(19) United States
(12) Patent Application Publication
(10) Pub. No.: US 2009/0080769 A1
(43) Pub. Date: Mar. 26, 2009

(54) Image data processing apparatus and method

(75) Inventors: Shuichi Kagawa, Tokyo (JP); Jun Someya, Tokyo (JP); Hiroaki Sugiura, Tokyo (JP)

Correspondence Address: BIRCH STEWART KOLASCH & BIRCH, PO BOX 747, FALLS CHURCH, VA, 22040-0747, US

(73) Assignee: Mutsubishi Electric Corporation

(21) Appl. No.: 12/232,897

(22) Filed: Sep. 25, 2008

(30) Foreign Application Priority Data
Sep. 26, 2007 (JP) 2007-248784

(51) Int. Cl. G06K 9/00

(52) U.S. Cl. 382/162; 382/168

(57) ABSTRACT

An image data processing apparatus receives trichromatic image data with values expressing red, green, and blue and generates information indicating the gamut of colors of the image data. The gamut information is obtained from maximum and minimum values, or values equivalent to the maximum and minimum values, pertaining to different color components during a prescribed time interval, and indicates the actual gamut of colors that appear during the prescribed time interval. The gamut information is appended to the image data, or output separately from the image data, for use in subsequent image processing.

### BACKGROUND OF THE INVENTION

1. Field of the Invention

The present invention relates generally to image data processing in cameras, scanners, and other image input devices, DVD players and other image reproducing devices, hard disk recorders and other image storing devices, and monitors or other image display devices. More particularly, the invention relates to an image data processing apparatus and method for providing information about the gamut of colors in image data, for use in processing the image data.

2. Description of the Related Art

The maximum color gamuts of the image signals used by image handling equipment differ depending on the color spaces of the color data. One internationally standardized color space is the sRGB color space specified in standard 61966-2-1 of the International Electrotechnical Commission (IEC 61966-2-1). Another is given by the BT.709 standard, ‘Parameter values for the HDTV standards for production and international programme exchange’ established for broadcast image (video) data by the Radiotelecommunication sector of the International Telecommunication Union (ITU-R). The sRGB and BT.709 standards define color gamuts based on cathode ray tube (CRT) characteristics and have identical chromaticity values for the primary colors (red, green, blue). In recent years, however, various types of imaging systems have become available and many of them display wider gamuts of colors than conventional CRTs. Furthermore, the gamut defined by the sRGB standard is not necessarily adequate for representing the color distributions of actual objects. For these reasons, color spaces with wider gamuts have been internationally standardized. One example is xvYCC (IEC 61966-2-4), which allows red, green, and blue values greater than 100% or less than 0% (negative values). This standard expands the ITU-R BT.709 gamut without changing the red, green, and blue chromaticity values located within the BT.709 color space.

Japanese Patent Application Publication No. 2003-37850 discloses a system in which metadata (tag data) representing parameters of the color space of image data are received together with image data through a communication channel and color conversion processing is performed according to the metadata.

The xvYCC wide-gamut color space will be taken as an example below. The gamut specified in the xvYCC standard is very wide, and is unlikely to be fully used in most of the scenes in an image data sequence. In other words, the gamut may change significantly from scene to scene. The gamut representable by imaging equipment, especially a monitor or other image display apparatus, is not large enough to include the entire xvYCC gamut. Accordingly, while some images may have gamuts within the displayable gamut of the apparatus in question, other images may have gamuts that exceed the gamut of the apparatus, and these images may exceed the displayable gamut by various degrees.

To obtain high image quality, image display apparatus performs image processing such as color conversion processing based on the relationship between its own displayable gamut and the gamut of the image data to be displayed. This processing requires gamut information about the image data. The xvYCC color space specifies the largest gamut that can be represented by image data, but not the gamut of colors that actually appears in individual image data sequences. That is, the parameters of the color space to which the image data conform do not always describe the actual gamut of colors in the image data. For better image processing, image display apparatus requires information about the actual gamut of the image data, but what type of gamut information to provide and how to generate the gamut information has been problematical.

### SUMMARY OF THE INVENTION

An object of the present invention is to provide an image data processing apparatus and method that detect the unknown gamuts of various color image data and output the information about the detected gamut or append gamut information to the image data.

The invention provides a novel image data processing apparatus for receiving first image data including trichromatic first color data with color values expressing red, green, and blue color components and obtaining the gamut of colors of the image data. The image data processing apparatus includes a maximum-minimum information generator for generating maximum and minimum information from the first color data or data generated from the first color data during a prescribed time interval and a gamut information generator for generating gamut information from the maximum and minimum information.

This image data processing apparatus can detect the gamut of colors of various first image data even if the gamut of the color data is not known in advance and can output the detected information as gamut information or append the detected information to the image data.

### BRIEF DESCRIPTION OF THE DRAWINGS

In the attached drawings:

FIG. 1 is a block diagram illustrating the image data processing apparatus in Embodiment 1 of the invention;

FIG. 2 is a table showing exemplary conditions for determining hue information H in the hue decision unit in FIG. 1;

FIGS. 3A to 3C are diagrams illustrating hues, input color data R1, G1, B1, and hue information when the entire gamut is divided into six hues;

FIG. 4 is a table showing an exemplary structure of the gamut information generated in Embodiment 1;

FIG. 5 is a block diagram illustrating a variation of the image data processing apparatus in Embodiment 1 of the invention;

FIG. 6 is a block diagram illustrating the image data processing apparatus in Embodiment 2 of the invention;

FIG. 7 is a block diagram illustrating an exemplary internal structure of the hue decision unit in FIG. 6;

FIG. 8 is a table showing exemplary conditions for deciding the value of the hue information H in the hue decision unit illustrated in FIG. 7;

FIGS. 9A to 9F are drawings respectively illustrating hues, chromatic color components r, g, b, y, m, c, and hue information H for red, yellow, green, cyan, blue magenta;

FIG. 10 is a table illustrating an exemplary structure of the hue information generated in Embodiment 2;

FIG. 11 is a block diagram illustrating the image data processing apparatus in Embodiment 3 of the invention;

FIG. 12 is a table illustrating an exemplary structure of the gamut information generated in Embodiment 3;

FIG. 13 is a table illustrating color data of primary color components and complementary color components in each hue;

FIG. 14 is a table illustrating an exemplary structure of the gamut information generated in a variation of Embodiment 3;

FIG. 15 is a block diagram illustrating the image data processing apparatus in Embodiment 4;

FIG. 16 is a block diagram illustrating an exemplary structure of the hue decision unit in FIG. 15;

FIG. 17 is a table illustrating exemplary conditions for deciding the values of the hue information H in the hue decision unit 3c in FIG. 16;

FIGS. 18A to 18F respectively illustrate the hues, chromatic color components r, g, b, y, m, c, and hue information H of red, yellow, green, cyan, blue, and magenta;

FIG. 19 is a table illustrating an exemplary structure of the gamut information generated in Embodiment 4;

FIG. 20 is a block diagram illustrating the image data processing apparatus in Embodiment 5 of the invention;

FIG. 21 is a table illustrating an exemplary structure of the gamut information generated in Embodiment 5;

FIG. 22 is a block diagram illustrating the image data processing apparatus in Embodiment 6 of the invention; and

FIG. 23 is a table illustrating an exemplary structure of the gamut information generated in Embodiment 6.

### DETAILED DESCRIPTION OF THE INVENTION

Embodiments of the invention will now be described with reference to the attached drawings, in which like elements are indicated by like reference characters.

### Embodiment 1

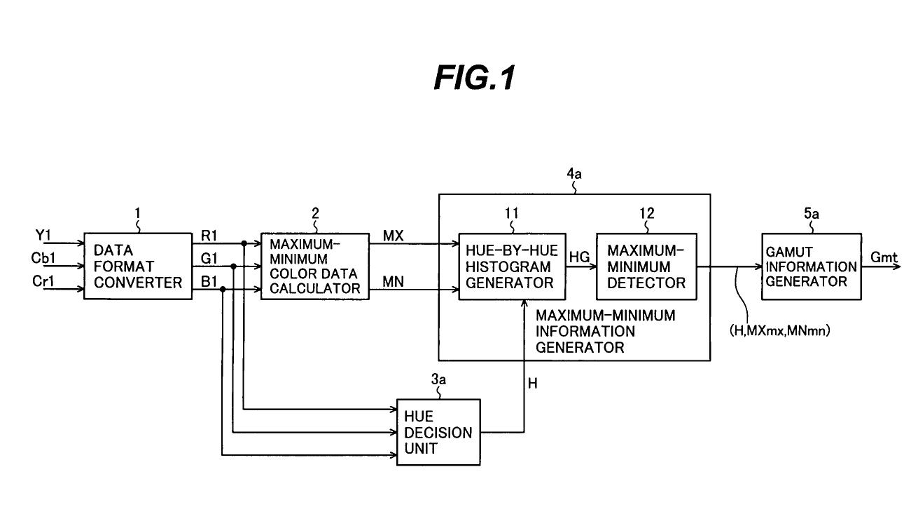

Referring to FIG. 1, the image data processing apparatus in Embodiment 1 includes a data format converter 1, a maximum-minimum color data calculator 2, a hue decision unit 3a, a maximum-minimum information generator 4a, and a gamut information generator 5a. In the image data processing apparatus in this embodiment, image data are input with input luminance data Y1 for each pixel and with color difference data Cb1, Cr1.

The luminance and color difference data Y1, Cb1, Cr1 are input to the data format converter 1 and converted to first color data R1, G1, B1. The conversion in the data format converter 1 is performed according to formulas determined by the type of input image data. The input color data R1, G1, B1, respectively representing red, green, and blue color components, may have values greater than 100% or less than 0% (negative values), especially in image data with a wide gamut of colors. Red, green, and blue (RGB) data with values of 0% represent black; RGB data with values of 100% represent white. When the image data are input as RGB color data (R1, G1, B1), the data format converter 1 is not required.

The first color data R1, G1, and B1 are input to the maximum-minimum color data calculator 2. For each pixel, the maximum-minimum color data calculator 2 selects (or calculates or detects) the maximum value (maximum color data value) MX and minimum value (minimum color data value) MN of the three first color data values R1, G1, and B1, and outputs the selected (or calculated or detected) values. The first color data R1, G1, and B1 are also input to the hue decision unit 3a.

The hue decision unit 3a generates hue information H representing the hue to which the first color data R1, G1, and B1 for each pixel belong (the hue to which the color represented by the first color data R1, G1, and B1 belongs) and outputs the result. In the image data processing apparatus in Embodiment 1, the entire spectrum of hues is divided into three hue ranges: a red range, a green range, and a blue range. The hue information H classifies each hue as red, green, or blue. The hue information H therefore takes three values representing these three hues.

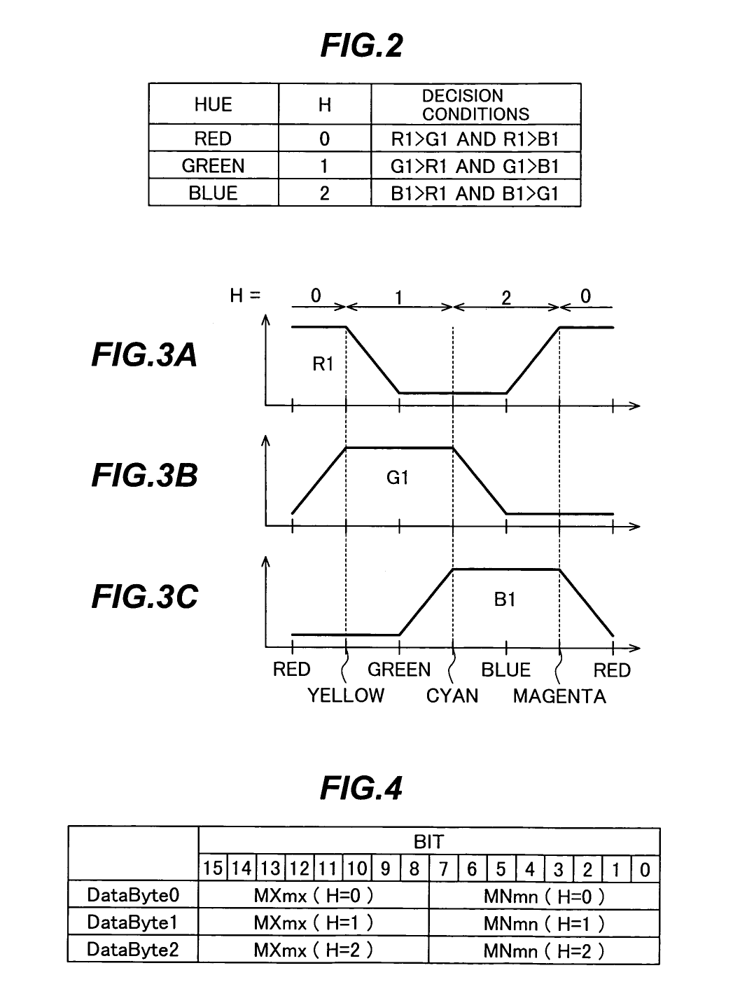

The hue decision unit 3a obtains the hue information H from the magnitude relationship among the first color data R1, G1, and B1. Exemplary hue decision conditions are shown in the table in FIG. 2. According to this table, when R1 is greater than both G1 and B1 (R1>G1 and R1>B1), the hue decision unit 3a identifies the hue as red and outputs a hue information value of zero (H=0).

FIGS. 3A to 3C schematically indicate the positions of pure red, green, and blue, their complementary hues yellow, cyan, and magenta, typical values of the first color data R1, G1, B1 at these hues and in ranges between them, and the hue information H in these ranges. FIGS. 3A to 3C also indicate the hue ranges in which each of the first color data R1, G1, and B1 is valid (the ranges in which R1, G1, and B1 may take values other than zero).

As indicated in FIG. 2, a hue information value of zero (H=0) indicates that the color represented by the first color data R1, G1, B1 has a red hue, that is, a hue in the range from yellow to magenta, centered on red.

A hue information value of one (H=1) indicates that the color represented by the first color data R1, G1, B1 has a green hue, that is, a hue in the range from yellow to cyan, centered on green.

A hue information value of two (H=2) indicates that the color represented by the first color data R1, G1, B1 has a blue hue, that is, a hue in the range from cyan to magenta, centered on blue.

The maximum values MX and the minimum values MN, and hue information H calculated for each pixel are input to the maximum-minimum information generator 4a. The maximum-minimum information generator 4a includes a hue-by-hue histogram generator 11 and a maximum-minimum detector 12.

The hue-by-hue histogram generator 11 collects the maximum values MX and the minimum values MN associated with each hue information value H from zero to two for a prescribed time interval, which may be one or several (two to ten) frame intervals, for example, and generates histograms HG(MX(H=0)), HG(MX(H=1)), HG(MX(H=2)), HG(MN(H=0)), HG(MN(H=1)), and HG(MN(H=2)) for each hue, which indicate the frequencies of the maximum and minimum data values. For example, HG(MX(H=0)) denotes a histogram of the maximum values MX of the generally red colors having a hue information value of zero (H=0) in the prescribed time interval.

The prescribed time interval need not be a fixed interval. The starting and ending of the prescribed time interval may be controlled by a signal generated in the image processing apparatus or an externally supplied signal. For example, in one possible scheme, an external histogram control signal is supplied and histograms are generated only when the histogram control signal is active; another possible scheme supplies an external timing signal synchronized with scene changes or other changes in the content of the image signal and the histograms are generated according to this timing signal. Still another scheme generates histograms not from the image data for all of the pixels but from data for only some of the pixels, thereby reducing memory requirements.

In the description below, as an example, one class in the histogram includes one data value, but one class may include a plurality (a predetermined number) of data values instead.

The maximum-minimum detector 12 refers to the hue histograms HG(MX(H=0)), HG(MX(H=1)), HG(MX(H=2)), HG(MN(H=0)), HG(MN(H=1)), and HG(MN(H=2)) and outputs maximum information MXmx and minimum information MNmn. The maximum information MXmx indicates a value MXmxq equivalent to the maximum MXmxt among the maximum values MX for each pixel over the prescribed time interval (the interval maximum value). The minimum information MNmn indicates a value MNmnq equivalent to the minimum MNmnt among the minimum values MN for each pixel over the prescribed time interval (the interval maximum value). This information MXmx, MNmn is generated for each of the three hues. The maximum information for the individual hues will be denoted MXmx(H=0), MXmx(H=1), and MXmx(H=2). Similarly, the minimum information for the individual hues will be denoted MNmn(H=0), MNmn(H=1), and MNmn(H=2).

The value MXmxq equivalent to the maximum value MXmxt is the data value at which the cumulative frequency (cumulative count) exceeds a predetermined threshold when the frequency data are cumulatively added in descending order in the relevant histogram (in which each data value constitutes one class). The value MNmnq equivalent to the minimum value MNmnt is the data value at which the cumulative frequency (cumulative count) exceeds a predetermined threshold when the frequency data are cumulatively added in ascending order in the relevant histogram.

When one class in the histogram includes a plurality of data values, the representative value (for example, the median value) of the class at which the cumulative frequency exceeds the predetermined threshold is the value MXmxq equivalent to the maximum value MXmxt, and similarly, the representative value (for example, the median value) of the class at which the cumulative frequency value exceeds the predetermined threshold is the value MNmnq equivalent to the maximum value MNmnt.

The value MXmxq equivalent to the maximum value and the value MNmnq equivalent to the minimum value are obtained as described above in order to suppress noise effects; the predetermined threshold is set in the range from 1% to 10% of the number of the pixels.

The maximum value MXmxt and the minimum value MNmnt may be used instead of the equivalent values MXmxq and MNmnq. In this case, a means for obtaining the maximum and minimum values of the data in the prescribed time interval may be used instead of the hue-by-hue histogram generator 11 and the maximum-minimum detector 12. This can simplify the configuration of the image data processing apparatus, although the effect of noise increases.

For simplicity, the value MXmxq equivalent to the maximum value will be considered to be a type of maximum value, and accordingly may just be referred to as the maximum value. Similarly, MNmnq may just be referred to as the minimum value. Regardless of the type of value used (MXmxq or MXmxt and MNmnq or MNmnt) the maximum information will be denoted MXmx and the minimum information will be denoted MNmn. The maximum information MXmx and minimum information MNmn are generated for each hue and output together with the hue information H for each hue in the form (H, MXmx, MNmn).

The gamut information generator 5a generates gamut information Gmt from the maximum and minimum information (H, MXmx, MNmn) for each hue output from the maximum-minimum information generator 4a, and outputs the gamut information Gmt. More specifically, the gamut information generator 5a generates the gamut information Gmt by combining the maximum and minimum information (H, MXmx, MNmn) for each of the three hues, and outputs the result.

If necessary, the gamut information generator 5a also outputs information specifying the color space of the input image data. The color space of the input image data can be determined from the type of image data or from metadata (tag data) appended to the image data. If information specifying the color space of the image data separately available (supplied by another method or via another route instead of being supplied in combination with Y1, Cb1, and Cr1), however, the gamut information generator 5a does not have to output color space information. This also applies to the other embodiments.

FIG. 4 shows an exemplary bit configuration of the gamut information Gmt. The maximum and minimum information for each hue is respectively stored as follows:

The minimum information MNmn of the red hue (H=0) is stored in the 0th to 7th bits (bits 0 to 7) of the zeroth data word (DataByte0);

The maximum information MXmx of the red hue (H=0) is stored in the 8th to 15th bits (bits 8 to 15) of the zeroth data word (DataByte0);

The minimum information MNmn of the green hue (H=1) is stored in the 0th to 7th bits (bits 0 to 7) of the first data word (DataByte1);

The maximum information MXmx of the green hue (H=1) is stored in the 8th to 15th bits (bits 8 to 15) of the first data word (DataByte1);

The minimum information MNmn of the blue hue (H=2) is stored in the 0th to 7th bits (bits 0 to 7) of the second data word (DataByte2); and

The maximum information MXmx of the blue hue (H=2) is stored in the 8th to 15th bits (bits 8 to 15) of the second data word (DataByte2).

This information constitutes the gamut information Gmt.

Gamut information Gmt may be generated at the end of each time interval in which histograms are generated in the hue-by-hue histogram generator 11, or when an external command signal is received.

The minimum value of the color data for each hue (such as the above minimum color data value MN) indicates the magnitude of the achromatic component of the color represented by the color data set (R1, G1, B1). Smaller magnitudes indicate greater saturation, and vice versa. That is, the minimum value MN of the color data (R1, G1, B1) for a hue is associated with the maximum saturation value of the hue (it alters or limits the maximum saturation value). In image data with a wide gamut, the minimum value may be less than 0%.

The maximum value of the color data for each hue (such as the above maximum color data value MX) is associated with the maximum value of the brightness of the color represented by the color data (R1, G1, B1) (it alters or limits the maximum brightness value). A smaller magnitude indicates lower brightness; a greater magnitude indicates higher brightness. In image data with a wide gamut, the maximum value may exceed 100%.

Image display apparatus can only display color data within the range from 0% to 100%, so appropriate conversion, especially of image data with a wide gamut, is required with reference to the gamut information.

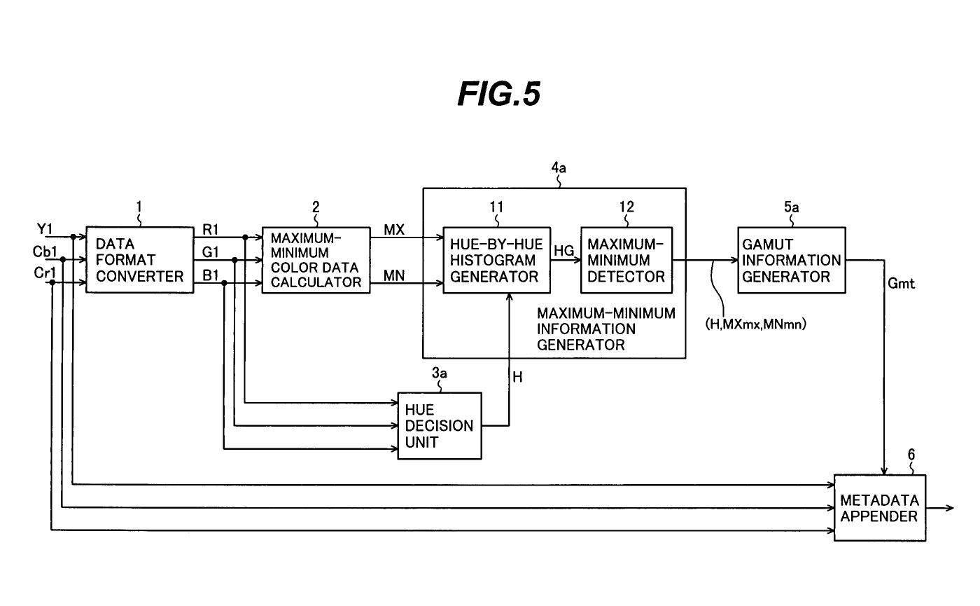

FIG. 5 illustrates another exemplary structure of the image data processing apparatus in this embodiment. In this structure, a metadata appender 6 is added to the structure shown in FIG. 1 to append the gamut information Gmt as metadata to the first image data. The color space information is also appended if necessary.

As described above, in the image data processing apparatus in Embodiment 1, maximum information MXmx and minimum information MNmn indicating the maximum and minimum values in the pixel data (R1, G1, B1) belonging to each hue (the maximum of the MX values for the hue and the minimum of the MN values for the hue) over a prescribed time interval are generated, and gamut information Gmt is generated from the maximum and minimum information MXmx, MNmn. It is therefore possible to detect the gamuts of colors of various types of image data, including types with unknown gamuts. The result can be output as gamut information Gmt or appended to the image data.

The gamut information representing the maximum and minimum values of the color data for the red, green, and blue hues is useful in image processing such as color conversion. For example, the gamut information for these hues can be compared with the gamuts of the same hues that can be generated by a particular type of image display apparatus in order to perform hue-by-hue color conversion suitable for the image display apparatus. As a result, the displayable gamut of colors of the apparatus can be used effectively. Such color conversion also includes so-called gamut mapping (color space transformation).

An exemplary basic operation used for color conversion is the matrix operation expressed in equation (1) below. R1, G1, B1 are the input color data and R2, G2, B2 are the output color data.

$$[ \begin{matrix}R 2 \\ G 2 \\ B 2\end{matrix} ] = [ \begin{matrix}arr & agr & abr \\ arg & agg & abg \\ arb & agb & abb\end{matrix} ] [ \begin{matrix}R 1 \\ G 1 \\ B 1\end{matrix} ] \qquad ( 1 )$$

In the above equation (1), arr, agr, abr, arg, agg, abg, arb, agb, and abb are matrix coefficients derived from mathematical formulas, a detailed description of which will be omitted.

In the matrix operation expressed by the equation (1), the matrix coefficients represent the conversion characteristics for red, green, and blue. Generating gamut information Gmt for the red, green, and blue hues individually simplifies the derivation of the matrix coefficients.

This image data processing apparatus may be embedded in image input devices, image reproducing apparatus, or image memory units and may be used to supply or store gamut information together with image data. The supplied or stored gamut information Gmt can then be used in further image processing to produce image data tailored to the requirements of image display apparatus or other image output equipment. When the novel image data processing apparatus is embedded in an image display apparatus, for example, the image display apparatus can use the gamut information to carry out image processing that keeps the image data within the displayable gamut of colors of the image display apparatus. In any case, providing separate gamut information for each hue enables sophisticated image processing to be performed with separate characteristics for each hue.

### Embodiment 2

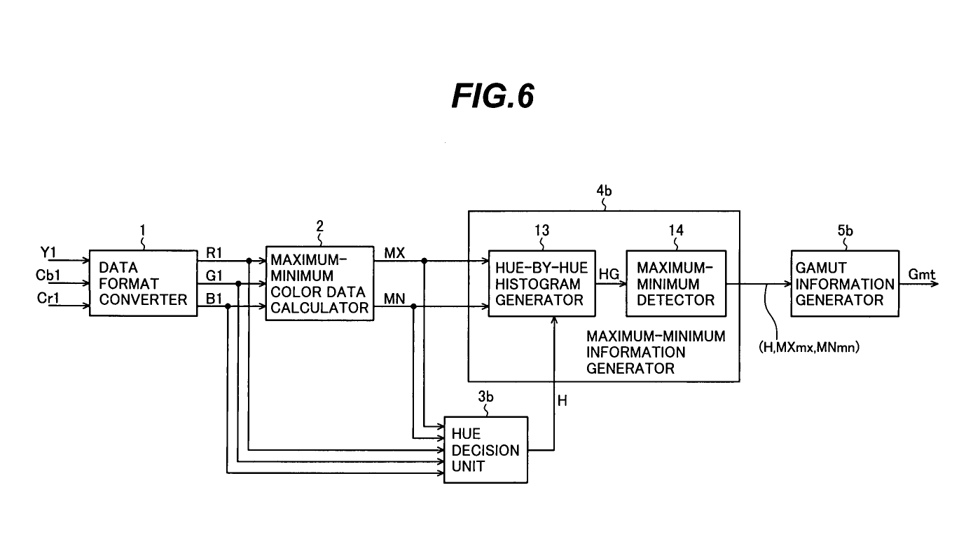

Referring to FIG. 6, the image data processing apparatus in Embodiment 2 includes a data format converter 1, a maximum-minimum color data calculator 2, a hue decision unit 3b, a maximum-minimum information generator 4b, and a gamut information generator 5b. The data format converter 1 and the maximum-minimum color data calculator 2 are the same as in Embodiment 1.

The luminance data Y1 and the color difference data Cb1, Cr1 are input to the data format converter 1 and converted to first color data R1, G1, B1. The first color data R1, G1, and B1 are input to the maximum-minimum color data calculator 2. The maximum-minimum color data calculator 2 selects maximum values MX and minimum values MN of the first color data R1, G1, and B1 for each pixel and outputs the selected values.

The hue decision unit 3b receives the first color data R1, G1, and B1, the maximum values MX, and the minimum values MN, calculates or generates hue information H representing the hue to which the first color data R1, G1, and B1 for each pixel belong, and outputs the result. In the image data processing apparatus in Embodiment 2, the entire spectrum of hues is divided into six hue ranges, more specifically, into red, yellow, green, cyan, blue, and magenta ranges. The hue information H takes six values representing these six hues.

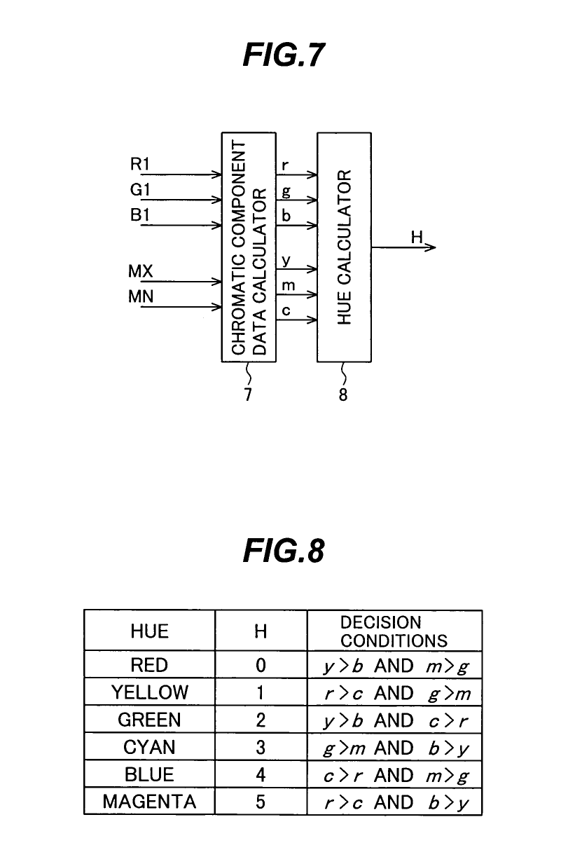

An exemplary configuration of the hue decision unit 3b will be described with reference to FIG. 7. The hue decision unit 3b includes a chromatic component data calculator 7 and a hue calculator 8.

The chromatic component data calculator 7 receives the first color data R1, G1, and B1, the maximum values MX, and the minimum values MN and outputs six items of chromatic component data obtained by subtraction: r=R1−MN, g=G1−MN, b=B1−MN, y=MX−B1, m=MX−G1, c=MX−R1.

The six items of chromatic component data are input to the hue calculator 8. The hue calculator 8 obtains the hue information H from the magnitude relationship among the six items of chromatic component data. Exemplary hue decision conditions are shown in the table in FIG. 8. When y is greater than b and m is greater than g (y>b and m>g), for example, the hue calculator 8 identifies the hue as red and outputs a hue information value of zero (H=0).

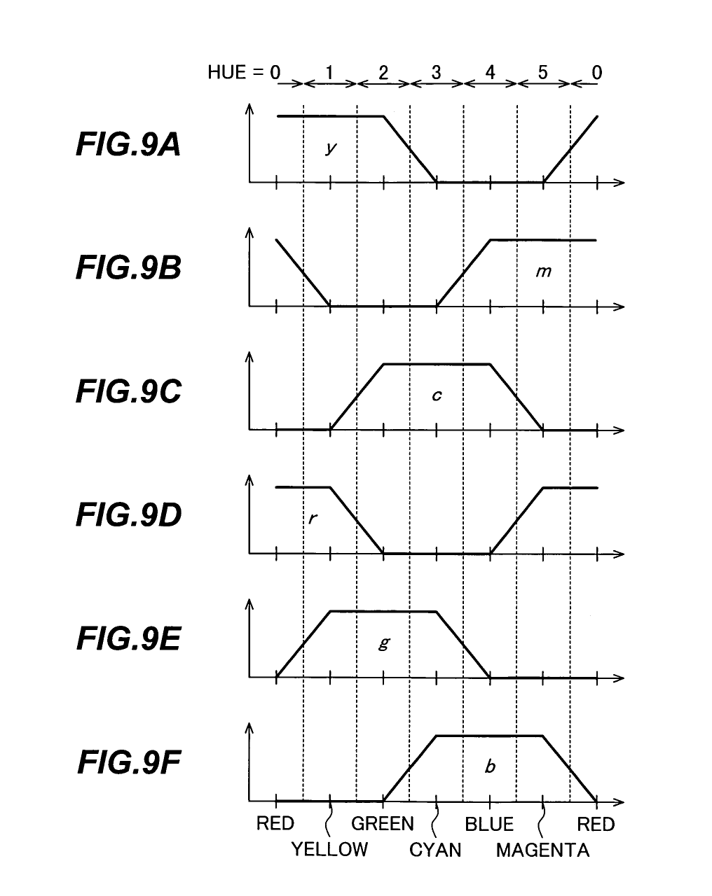

FIGS. 9A to 9F schematically indicate the positions pure red, yellow, green, cyan, blue, and magenta, typical values of the chromatic component data r, b, g, y, m, c at these hues and in ranges between them, and the hue information H in these ranges. FIGS. 9A to 9F also indicate the hue ranges in which each of the chromatic component data y, m, c, r, g, and b is valid (the ranges in which the chromatic component data y, m, c, r, g, and b may take values other than zero).

A hue information value of zero (H=0) indicates that the hue of the color represented by the first color data R1, G1, B1 is red (lies within the red hue range);

A hue information value of one (H=1) indicates that the hue of the color represented by the first color data R1, G1, B1 is yellow;

A hue information value of two (H=2) indicates that the hue of the color represented by the first color data R1, G1, B1 is green;

A hue information value of three (H=3) indicates that the hue of the color represented by the first color data R1, G1, B1 is cyan;

A hue information value of four (H=4) indicates that the hue of the color represented by the first color data R1, G1, B1 is blue;

A hue information value of five (H=5) indicates that the hue of the color represented by the first color data R1, G1, B1 is magenta.

When the first color data do not satisfy any of the hue decision conditions, such as when an achromatic color (R1=G1=B1) is input, the hue calculator 8 outputs a hue information value other than zero to five.

The maximum values MX, minimum values MN, and hue information H calculated for each pixel are input to the maximum-minimum information generator 4b. The maximum-minimum information generator 4b includes a hue-by-hue histogram generator 13 and a maximum-minimum detector 14.

The hue-by-hue histogram generator 13 collects the maximum values MX and the minimum values MN associated with each hue information value H from zero to five for a prescribed time interval, and generates histograms HG(MX(H=0)) to HG(MX(H=5)) and HG(MN(H=0)) to HG(MN(H=5)) for each hue, which indicate the frequencies of the maximum and minimum data values.

The maximum-minimum detector 14 refers to the hue histograms HG(MX(H=0)) to HG(MX(H=5)) and HG(MN(H=0)) to HG(MN(H=5)) and outputs maximum information MXmx and minimum information MNmn. The maximum information MXmx indicates a value MXmxq equivalent to the maximum MXmxt value among the maximum values MX for each pixel over the prescribed time interval. The minimum information MNmn indicates a value MNmnq equivalent to the minimum MNmnt among the minimum values MN for each pixel over the prescribed time interval. This information MXmx, MNmn is generated for each of the six hues and output together with the hue information for each hue in the form (H, MXmx, MNmn).

The gamut information generator 5b generates gamut information Gmt from the maximum and minimum information (H, MXmx, MNmn) for each hue output from the maximum-minimum information generator 4b, and outputs the gamut information Gmt. More specifically, the gamut information generator 5b generates the gamut information Gmt by combining the maximum and minimum information (H, MXmx, MNmn) for each of the six hues, and outputs the result.

As in Embodiment 1, the maximum value MXmxt and minimum value MNmnt may be used instead of the value MXmxq equivalent to the maximum value and the value MNmnq equivalent to the minimum value.

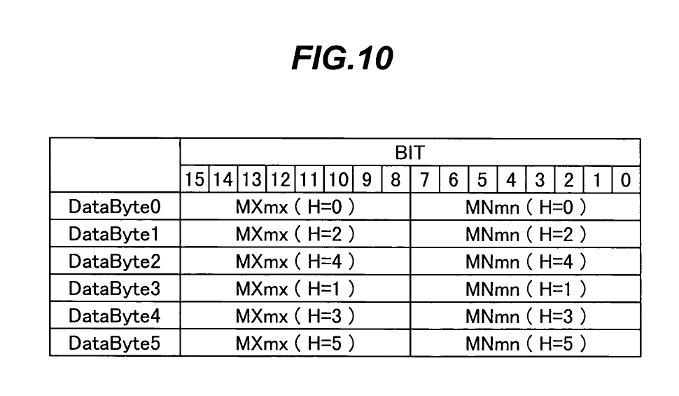

FIG. 10 shows an exemplary bit configuration of the gamut information Gmt. The maximum and minimum information for each hue is respectively stored as follows:

The maximum information MXmx and the minimum information MNmn of the red hue (H=0) is stored in DataByte0;

The maximum information MXmx and the minimum information MNmn of the green hue (H=2) is stored in DataByte1;

The minimum information MNmn and the minimum information MNmn of the blue hue (H=4) is stored in DataByte2;

The maximum information MXmx and the minimum information MNmn of the yellow hue (H=1) is stored in DataByte3;

The minimum information MNmn and the minimum information MNmn of the cyan hue (H=3) is stored in DataByte4); and

The maximum information MXmx and the minimum information MNmn of the magenta hue (H=5) is stored in DataByte5.

For each hue, the maximum information MXmx is stored in the 8th to 15th bits (bits 8 to 15) and the minimum information MNmn is stored in the 0th to 7th bits (bits 0 to 7).

This information constitutes the gamut information Gmt.

As described above, in the image data processing apparatus in Embodiment 2, maximum information MXmx and minimum information MNmn indicating the maximum and minimum values in the pixel data (R1, G1, B1) belonging to each hue (the maximum of the MX values for the hue and the minimum of the MN values for the hue) over a prescribed time interval are generated, and gamut information Gmt is generated from the maximum and minimum information MXmx, MNmn. It is therefore possible to detect the gamuts of colors of various types of image data, including types with unknown gamuts. The result may be output as gamut information Gmt or may be appended to the image data.

The gamut information representing the maximum and minimum values of the color data for the red, yellow, green, cyan, blue, and magenta hues is useful in image processing such as color conversion. For example, the gamut information for these hues can be compared with the gamuts of the same hues that can be generated by a particular type of image display apparatus in order to perform hue-by-hue color conversion suitable for the image display apparatus. As a result, the displayable gamut of colors of the apparatus can be used effectively.

### Embodiment 3

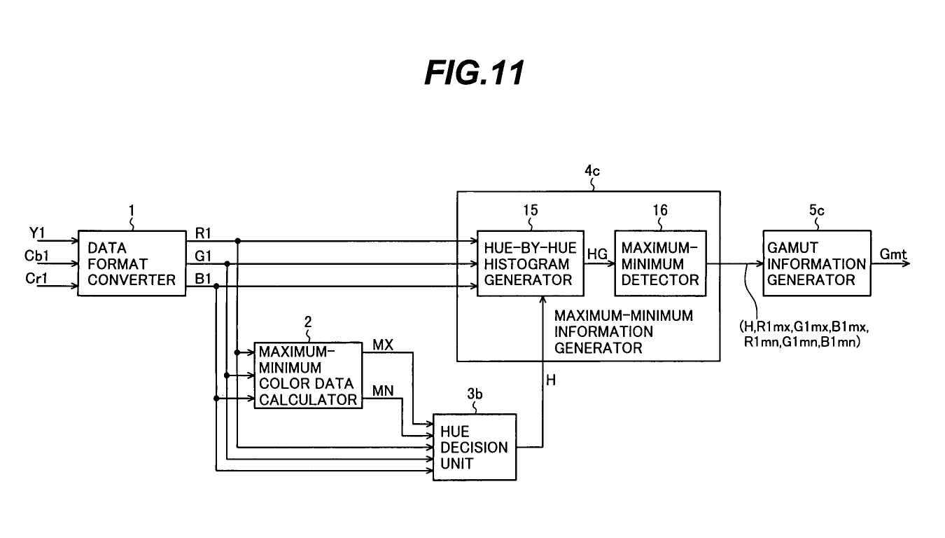

Referring to FIG. 11, the image data processing apparatus in Embodiment 3 includes a data format converter 1, a maximum-minimum color data calculator 2, a hue decision unit 3b, a maximum-minimum information generator 4c, and a gamut information generator 5c. The data format converter 1, maximum-minimum color data calculator 2, and hue decision unit 3b are the same as in Embodiment 2.

The luminance data Y1 and the color difference data Cb1, Cr1 are input to the data format converter 1 and converted to first color data R1, G1, B1. The first color data R1, G1, and B1 are input to the maximum-minimum color data calculator 2. The maximum-minimum color data calculator 2 selects maximum values MX and minimum values MN of the first color data R1, G1, and B1 for each pixel and outputs the selected values.

The hue decision unit 3a receives the first color data R1, G1, and B1, the maximum values MX and the minimum values MN, and generates hue information H representing hues to which the input color data R1, G1, and B1 for each pixel belong and outputs the result. In the image data processing apparatus in Embodiment 3, the entire spectrum of hues is divided into six hue ranges, representing red, yellow, green, cyan, blue, and magenta. The hue information H takes six values representing these six hues.

The hue information H is input to the maximum-minimum information generator 4c. The maximum-minimum information generator 4c includes a hue-by-hue histogram generator 15 and a maximum-minimum detector 16.

The hue-by-hue histogram generator 15 collects the first color data R1, G1, and B1 associated with each hue information value H from zero to five for a prescribed time interval, and generates histograms HG(R1(H=0)) to HG(R1(H=5)), HG(G1(H=0)) to HG(G1(H=5)), and HG(B1(H=0)) to HG(B1(H=5)) for each hue, which indicate the frequencies of occurrence of each R1 data value, each G1 data value, and each B1 data value among pixels having the designated hue.

The maximum-minimum detector 16 refers to the hue histograms HG(R1(H=0)) to HG(R1(H=5)), HG(G1(H=0)) to HG(G1(H=5)), and HG(B1(H=0)) to HG(B1(H=5)) and outputs maximum information R1mx, G1mx, B1mx and the minimum information R1mn, G1mn, B1mn. The maximum information R1mx, G1mx, B1mx respectively indicate values R1mxq, G1mxq, B1mxq that are respectively equivalent to the maximum values R1mxt, G1mxt, B1mxt of the first color data R1, G1, B1 over the prescribed time interval. The minimum information R1mn, G1mn, B1mn respectively indicate values R1mnq, G1mnq, and B1mnq that are equivalent to the minimum values R1mnt, G1mnt, B1mnt of the first color data R1, G1, B1 over the prescribed time interval. The maximum information R1mx, G1mx, B1mx and the minimum information R1mn, G1mn, B1mn are generated for each of the six hues and output together with the hue information H for each hue in the form (H, R1mx, G1mx, B1mx, R1mn, G1mn, B1mn).

The histograms generated in the hue-by-hue histogram generator 15 are used to detect the values equivalent to the maximum values and the minimum values. The histograms therefore need not cover the entire range of values the first color data may take but may be partial histograms, covering only ranges around the maximum and minimum values, for example. This also applies to the other embodiments of the invention.

The gamut information generator 5c generates gamut information Gmt from the maximum and minimum information (H, R1mx, G1mx, B1mx, R1mn, G1mn, B1mn) for each hue output from the maximum-minimum information generator 4b, and outputs the result. More specifically, the gamut information generator 5b generates the gamut information Gmt by combining the maximum information R1mx, G1mx, B1mx and minimum information R1mn, G1mn, B1mn for each of the six hues, and outputs the result.

As described in Embodiments 1 and 2, the maximum values R1mx, G1mx, B1mx and minimum values R1mn, G1mn, B1mn may be used instead of the values R1mxq, G1mxq, B1mxq equivalent to the maximum values and the values R1mnq, G1mnq, B1mnq equivalent to the minimum values.

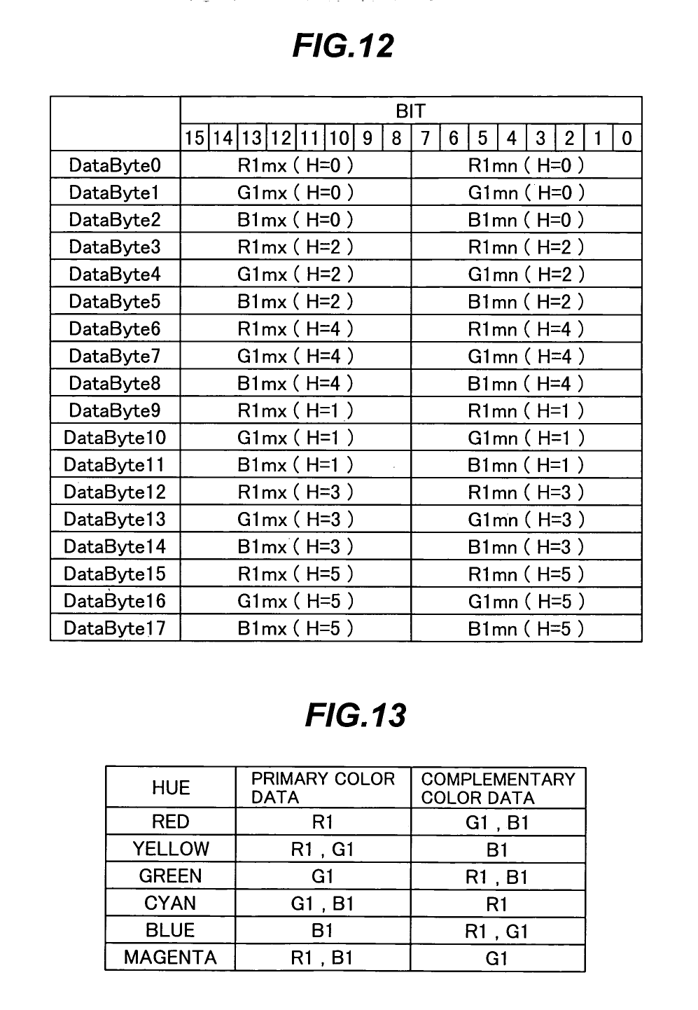

FIG. 12 shows an exemplary bit configuration of the gamut information Gmt. In this example, the maximum and minimum information for each hue is respectively stored as follows:

The maximum information R1mx, G1mx, B1mx and the minimum information R1mn, G1mn, B1mn of the first color data R1, G1, B1 of the red hue (H=0) are stored in DataByte0 to Databyte2;

The maximum information R1mx, G1mx, B1mx and the minimum information R1mn, G1mn, B1mn of the first color data R1, G1, B1 of the green hue (H=2) are stored in DataByte3 to DataByte5;

The maximum information R1mx, G1mx, B1mx and the minimum information R1mn, G1mn, B1mn of the first color data R1, G1, B1 of the blue hue (H=4) are stored in DataByte6 to Databyte8;

The maximum information R1mx, G1mx, B1mx and the minimum information R1mn, G1mn, B1mn of the first color data R1, G1, B1 of the yellow hue (H=1) are stored in DataByte9 to DataByte11;

The maximum information R1mx, G1mx, B1mx and the minimum information R1mn, G1mn, B1mn of the first color data R1, G1, B1 of the cyan hue (H=3) are stored in DataByte12 to Databyte14; and

The maximum information R1mx, G1mx, B1mx and the minimum information R1mn, G1mn, B1mn of the first color data R1, G1, B1 of the magenta hue (H=5) are stored in DataByte15 to DataByte17.

For each hue, the maximum information R1mx, G1mx, B1mx is stored in the 8th to 15th bits (bits 8 to 15) and the minimum information R1mn, G1mn, B1mn is stored in the 0th to 7th bits (bits 0 to 7).

This information constitutes the gamut information Gmt.

As described above, in the image data processing apparatus in Embodiment 3, the maximum information R1mx, G1mx, B1mx and the minimum information R1mn, G1mn, B1mn indicating the maximum value and the minimum values of the first color data (R1, G1, B1) belonging to each hue over a prescribed time interval are generated, and gamut information Gmt is generated from the maximum and minimum information R1mx, G1mx, B1mx, R1mn, G1mn, B1mn. It is therefore possible to detect the gamuts of colors of various types of image data, including types with unknown gamuts. The result can be output as gamut information Gmt or appended to the image data.

Information indicating which of the first color data R1, G1, B1 are the maximum and the minimum is also stored for each hue. Image display apparatus can refer to this information to perform appropriate color conversion processing for each hue, thereby enabling effective use of the displayable gamut of the apparatus. However, the maximum-minimum information generator 4c and hue-by-hue histogram generator 15 have to generate a histogram for each of the three primary colors in the first color data, which increases the circuit size and the amount of computation.

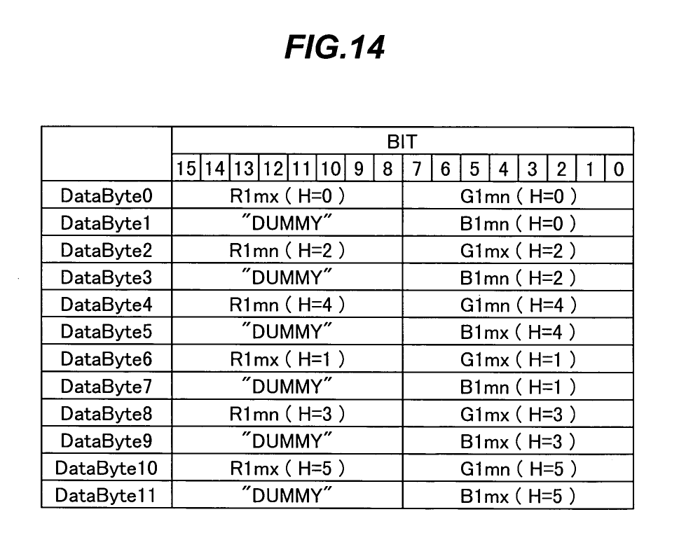

In general, the maximum value in the first color data R1, G1, B1 for a given hue is the primary color component, or one of the two primary color components, of the hue and the minimum value in the first color data is the primary color component, or one of the two primary color components, of the complementary hue. The primary color components of the six hues and their complementary hues are shown in the table in FIG. 13. Because of these relationships, the gamut information Gmt may have a bit configuration like the one shown in FIG. 14, whereby the data size can be reduced. In this bit configuration, for each hue, only the maximum values of primary colors relevant to the hue and minimum values of primary colors relevant to the complementary hue are stored. For the red hue (H=0), for example, the maximum red information R1mx, the minimum green information G1mn, and the minimum blue information B1mn are stored in DataByte0 and Databyte1; for the yellow hue (H=1), the maximum red information R1mx, the maximum green information G1mx, and the minimum blue information B1mn are stored in DataByte6 and Databyte7.

In FIG. 14, ‘DUMMY’ indicates dummy data that take an arbitrary value such as zero, for example, and are not processed as meaningful data. The data size can be reduced by eliminating the dummy data and packing the rest of the data together, thus storing the maximum green information G1mx of the green hue (H=2) in bits 9 to 15 in DataByte1, for example. The bit configuration with dummy bytes as shown in FIG. 14 has the advantage, however, that the gamut information Gmt can be referenced more easily. More specifically, in this configuration, for all hues, the upper eight bits of each even numbered databyte store R1 data, the lower eight bits of each even numbered databyte store G1 data, and the lower eight bits of each odd numbered databyte store B1 data, offering the advantage of easier circuit design or software programming.

### Embodiment 4

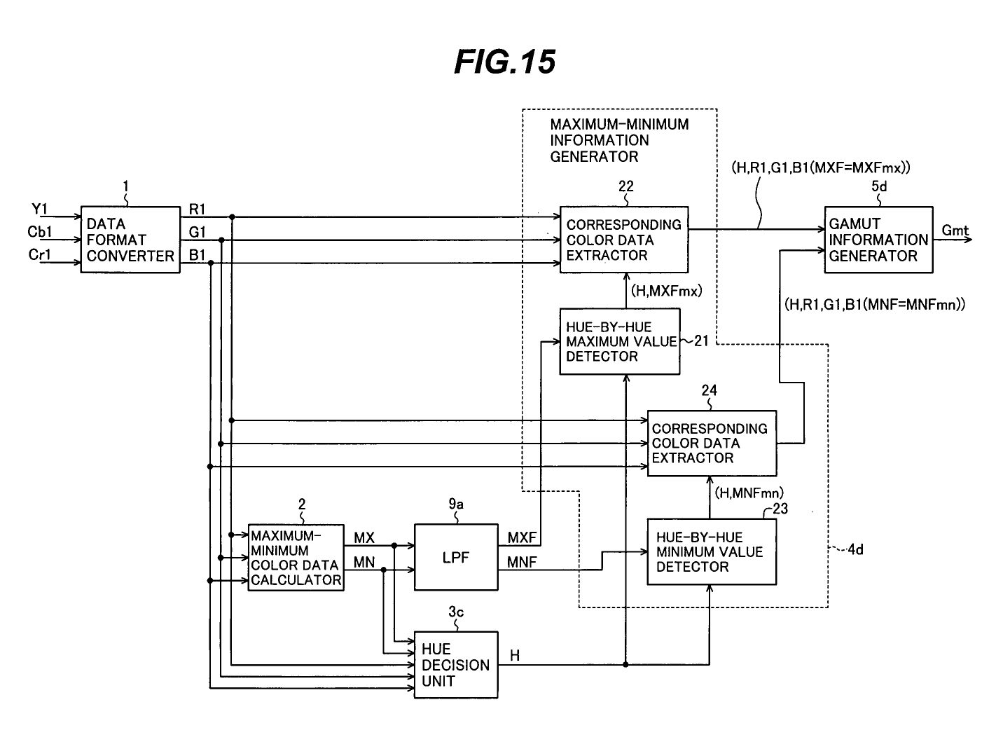

Referring to FIG. 15, the image data processing apparatus in Embodiment 4 includes a data format converter 1, a maximum-minimum color data calculator 2, a hue decision unit 3c, a low-pass filter (LPF) 9a, a maximum-minimum information generator 4d, and a gamut information generator 5d.

The data format converter 1 and the maximum-minimum color data calculator 2 are the same as in Embodiment 1.

The luminance data Y1 and color difference data Cb1, Cr1 are input to the data format converter 1 and converted to first color data R1, G1, B1. The first color data R1, G1, and B1 are input to the maximum-minimum color data calculator 2. The maximum-minimum color data calculator 2 selects the maximum value MX and minimum value MN among the first color data R1, G1, and B1 for each pixel and outputs the selected values.

The hue decision unit 3c receives the first color data R1, G1, and B1, the maximum values MX, and the minimum values MN, generates hue information H representing the hue to which the input color data R1, G1, and B1 for each pixel belong, and outputs the result. As in Embodiments 2 and 3, the entire spectrum of hues is divided into six hue ranges: red, yellow, green, cyan, blue, and magenta. The hue information H takes six values representing these six hue ranges.

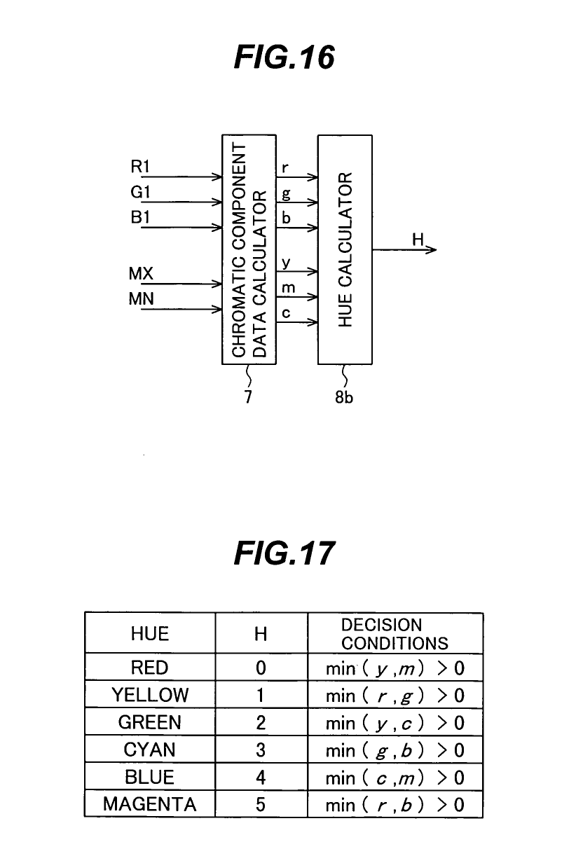

An exemplary configuration of the hue decision unit 3c will be described with reference to FIG. 16. The hue decision unit 3c includes a chromatic component data calculator 7 and a hue calculator 8b.

Like the hue decision unit 3b illustrated in FIG. 7, the chromatic component data calculator 7 receives the first color data R1, G1, and B1, the maximum values MX, and the minimum values MN and outputs six items of chromatic component data obtained by subtraction: r=R1−MN, g=G1−MN, b=B1−MN, y=MX−B1, m=MX−G1, c=MX−R1.

The six items of chromatic component data are input to the hue calculator 8b. The hue calculator 8b obtains the hue information H from magnitude relationships among the six items of chromatic component data. Exemplary hue decision conditions are shown in the table in FIG. 17. The symbol min(A, B) indicates the minimum of arbitrary quantities A and B. When min(y, m) is greater than zero, for example, the hue calculator 8b identifies the hue as red and outputs a hue information value of zero (H=0).

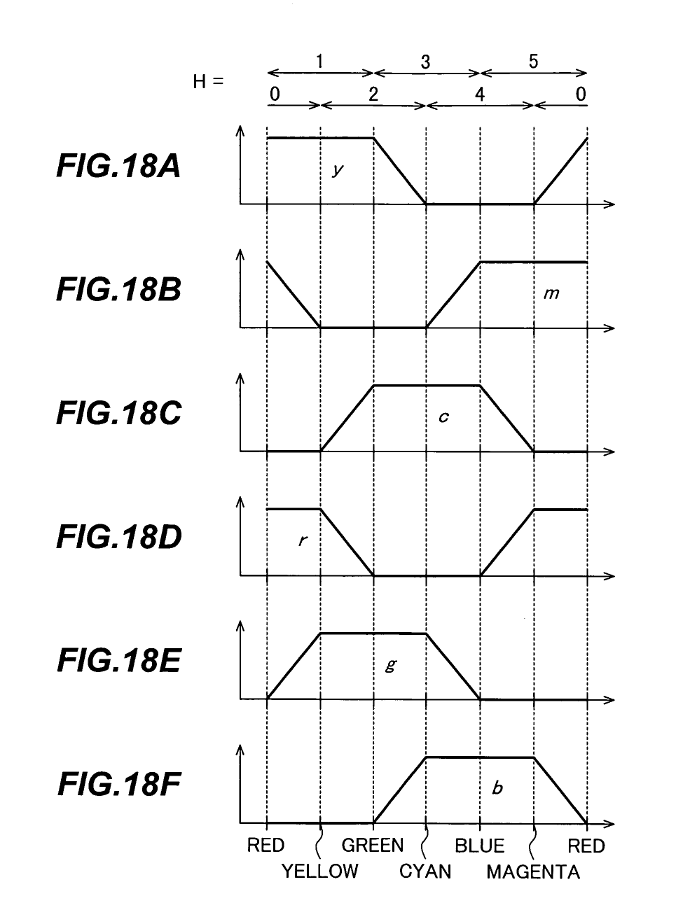

FIGS. 18A to 18F respectively indicate the positions of pure red, yellow, green, cyan, blue, and magenta, typical values of the chromatic component data r, b, g, y, m, c at these hues and in ranges between them, and the hue information H in these ranges. FIGS. 18A to 18F also indicate the hue ranges in which each of the chromatic component data y, m, c, r, g, and b are valid (the ranges in which the chromatic component data y, m, c, r, g, and b may take values other than zero).

As in Embodiment 2, the hue information H is output for each of the six hues, but different decision conditions are used, as follows:

A hue information value of zero (H=0) indicates that the hue of the color represented by the first color data R1, G1, B1 belongs to (lies within) the hue range from yellow to magenta, centered on red.

A hue information value of one (H=1) indicates that the hue of the color represented by the first color data R1, G1, B1 belongs to the range from red to green, centered on yellow.

A hue information value of two (H=2) indicates that the hue of the color represented by the first color data R1, G1, B1 belongs to the range from yellow to cyan, centered on green.

A hue information value of three (H=3) indicates that the hue of the color represented by the first color data R1, G1, B1 belongs to the range from green to blue, centered on cyan.

A hue information value of four (H=4) indicates that the hue of the color represented by the first color data R1, G1, B1 belongs to the range from cyan to magenta, centered on blue.

A hue information value of five (H=5) indicates that the hue of the color represented by the first color data R1, G1, B1 belongs to the range from blue to red, centered on magenta.

The hue information H is input to the maximum-minimum information generator 4d.

The maximum-minimum information generator 4d includes a hue-by-hue maximum value detector 21, a corresponding color data extractor 22, a hue-by-hue minimum value detector 23, and a corresponding color data extractor 24.

The maximum values MX and the minimum values MN from the maximum-minimum color data calculator 2 are also input to the low-pass filter 9a. The low-pass filter 9a filters the maximum and minimum values MX, MN and outputs the filtered maximum and minimum values MXF, MNF. The low-pass filter 9a is included in order to reduce noise in the maximum and minimum values MX, MN, so it may be omitted. Alternatively, a low-pass filter may be inserted to filter the first color data R1, G1, B1.

A low-pass filter in which a weighted average of the maximum and minimum values MX, MN for a series of pixels in the input data may be used as the low-pass filter 9a, for example.

The hue-by-hue maximum value detector 21 refers to the hue information H, obtains the greatest value MXFmx of the filtered maximum values MXF for each of the six hues in a prescribed time interval, and outputs the MXFmx values together with the corresponding hue information H in the form (H, MXFmx).

Corresponding color data extractor 22 extracts the first color data R1, G1, B1 of a pixel that produced the maximum MXFmx value, and outputs maximum information by combining this result with the hue information H in the form (H, R1, G1, B1 (MXF=MXFmx)).

The hue-by-hue minimum value detector 23 refers to the hue information H, obtains the least value MNFmn of the filtered minimum values MNF for each of the six hues in the prescribed time interval, and outputs the MNFmn value together with the corresponding hue information H in the form (H, MNFmn).

Corresponding color data extractor 24 extracts the first color data R1, G1, B1 of a pixel that produced the MNFmn value, and outputs minimum information by combining this result with the hue information H in the form (H, R1, G1, B1 (MNF=MNFmn)).

The gamut information generator 5d generates gamut information Gmt from the maximum information (H, R1, G1, B1 (MXF=MXFmx)) and minimum information (H, R1, G1, B1 (MNF=MNFmn)) for each hue, and outputs the gamut information Gmt. More specifically, the gamut information generator 5a generates the gamut information Gmt by combining the maximum and minimum information (H, R1, G1, B1 (MXF=MXFmx)), (H, R1, G1, B1 (MNF=MNFmn)) for each of the six hues, and outputs the result.

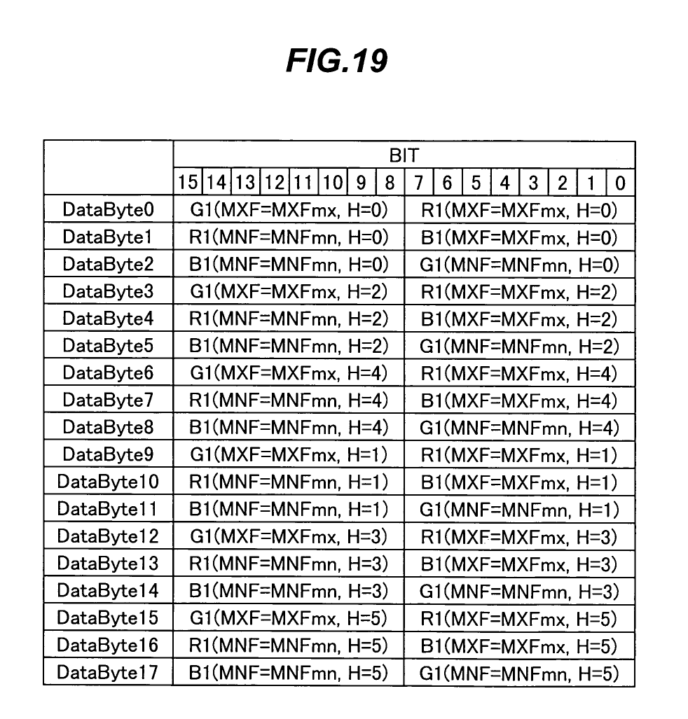

FIG. 19 shows an exemplary bit configuration of the gamut information Gmt generated in the gamut information generator 5d.

In this example, the first color data R1, G1, B1 of a pixel that produced the maximum value MXFmx among the filtered maximum values MXF for the red hue (H=0) within a prescribed time interval, denoted R1(MXF=MXFmx, H=0), G1(MXF=MXFmx, H=0), B1(MXF=MXFmx, H=0), are stored in bits 0 to 15 in DataByte0 and bits 0 to 7 in DataByte1; the first color data R1, G1, B1 of a pixel that produced the minimum value MNFmn among the filtered maximum values MNF for the red hue (H=0) within a prescribed time interval, denoted R1(MNF=MNFmn, H=0), G1(MNF=MNFmn, H=0), B1(MNF=MNFmn, H=0) are stored in bits 8 to 15 in DataByte1 and bits 0 to 15 in Databyte2. Similar data for other hues are stored as follows:

Data for green (H=2) are stored in DataByte3 to DataByte5;

Data for blue (H=4) are stored in DataByte6 to DataByte8;

Data for yellow (H=1) are stored in DataByte9 to DataByte11;

Data for cyan (H=3) are stored in DataByte12 to DataByte14; and

Data for magenta (H=5) are stored in DataByte15 to DataByte17.

This information constitutes the gamut information Gmt.

As described above, this image data processing apparatus obtains the maximum value MXFmx and the minimum value MNFmn among the filtered maximum values MXF and the filtered minimum values MNF for each pixel of the first color data R1, G1, B1 for each of the six hues of red, yellow, green, cyan, blue, and magenta, generates information including the first color data R1, G1, B1 of the pixel that produced the maximum value MXFmx, in the form (H, R1, G1, B1 (MXF=MXFmx), and information including the first color data R1, G1, B1 of the pixel that produced the minimum value MNFmn, in the form (H, R1, G1, B1 (MNF=MNFmn), and generates the gamut information Gmt from this information. This makes it possible to generate gamut information including maximum and minimum value information for the first color data belonging to each of the six hues in a form suitable for sophisticated color conversion processing. Information indicating which of the first color data R1, G1, B1 are the maximum and minimum is also stored, together with the set of the first color data that yielded the maximum and minimum.

This information can be used in image display apparatus to perform sophisticated image processing with separate characteristics for each hue, resulting in effective use of the displayable gamut of the apparatus. First color data R1=0.9, G1=0.2, B1=−0.2 and first color data R1=0.5, G1=0.1, B1=−0.2, for example, have the same minimum value but show a difference in saturation. The image data processing apparatus in this embodiment makes it possible to generate gamut information that indicates such differences.

### Embodiment 5

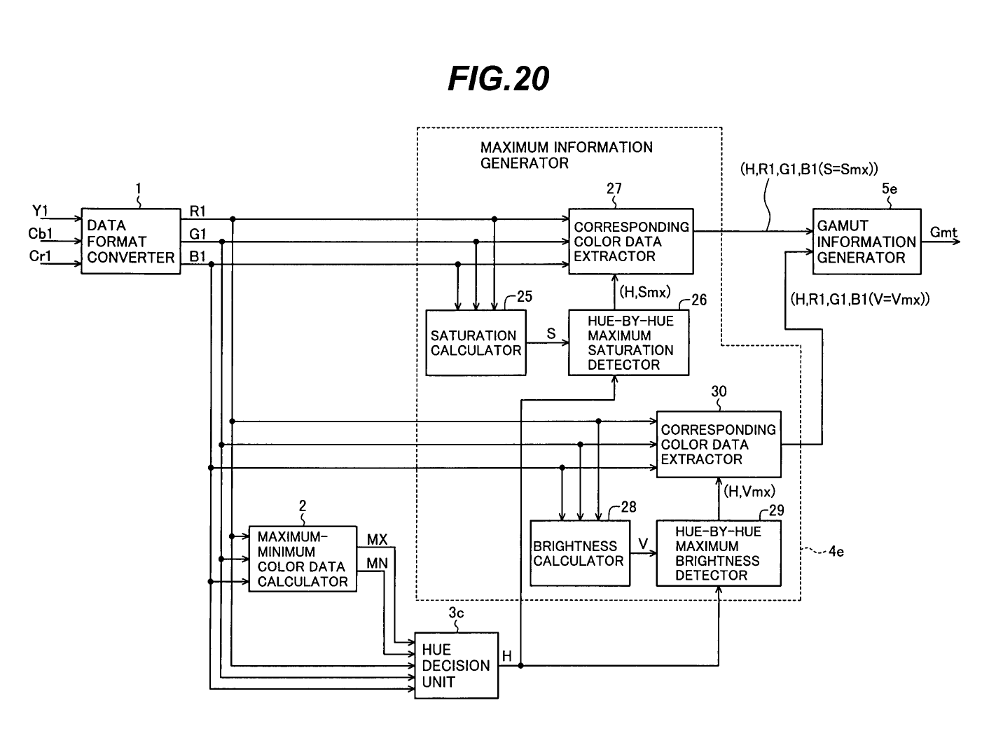

Referring to FIG. 20, the image data processing apparatus in Embodiment 5 includes a data format converter 1, a maximum-minimum color data calculator 2, a hue decision unit 3c, a maximum information generator 4e, and a gamut information generator 5e. The data format converter 1, maximum-minimum color data calculator 2, and hue decision unit 3c are the same as in Embodiment 4.

The luminance data Y1 and color difference data Cb1, Cr1 are input to the data format converter 1 and converted to first color data R1, G1, B1. The first color data R1, G1, and B1 are input to the maximum-minimum color data calculator 2. The maximum-minimum color data calculator 2 selects maximum values MX and minimum values MN of the first color data R1, G1, and B1 for each pixel and outputs the selected values.

The hue decision unit 3c receives the first color data R1, G1, and B1, the maximum values MX, and the minimum values MN, calculates hue information H representing the hue to which the input color data R1, G1, and B1 for each pixel belong, and outputs the result. As in Embodiments 3 and 4, the entire spectrum of hues is divided into six hue ranges: red, yellow, green, cyan, blue, and magenta. The hue information H takes six values representing these six hue ranges.

The hue information H is input to the maximum information generator 4e. The maximum information generator 4e includes a saturation calculator 25, a hue-by-hue maximum saturation detector 26, a corresponding color data extractor 27, a brightness calculator 28, a hue-by-hue maximum brightness detector 29, and a corresponding color data extractor 30.

The saturation calculator 25 calculates saturation S from the first color data R1, G1, B1.

The hue-by-hue maximum saturation detector 26 receives data indicating the saturation S calculated in the saturation calculator 25, and determines the maximum saturation value Smx for each hue.

The corresponding color data extractor 27 extracts the first color data R1, G1, B1 of the pixel that produced the maximum saturation value found by the hue-by-hue maximum saturation detector 26, stores the result, and outputs the data as maximum saturation information in the form (H, R1, G1, B1 (S=Smx)) for each hue.

The saturation S for each pixel can be obtained from either of the following equations:

S=MX−MN

or

S=(MX−MN)/MX

The brightness calculator 28 calculates brightness V from the first color data R1, G1, B1.

The hue-by-hue maximum brightness calculator 29 receives data indicating the brightness V calculated in the brightness calculator 28, and obtains the maximum brightness value Vmx for each hue.

The corresponding color data extractor 30 extracts the first color data R1, G1, B1 of the pixel that produced the maximum brightness value found by the hue-by-hue maximum saturation detector 26, stores the result, and outputs the data as maximum brightness information in the form (H, R1, G1, B1 (V=Vmx)) for each hue.

The brightness V for each pixel can be obtained as follows:

V=MX

or

V=ar×R1+ag×G1+ab×B1

where ar, ag, and ab are coefficients.

The maximum value of the brightness V in a prescribed time interval will be denoted Vmxt.

The gamut information generator 5e generates the gamut information Gmt from the maximum saturation information (H, R1, G1, B1 (S=Smx)) and maximum brightness information (H, R1, G1, B1 (V=Vmx)) for each hue. More specifically, the gamut information generator 5e generates the gamut information Gmt by combining the maximum saturation and maximum brightness information (H, R1, G1, B1 (S=Smx)), (H, R1, G1, B1 (V=Vmx)) for each of the six hues, and outputs the result.

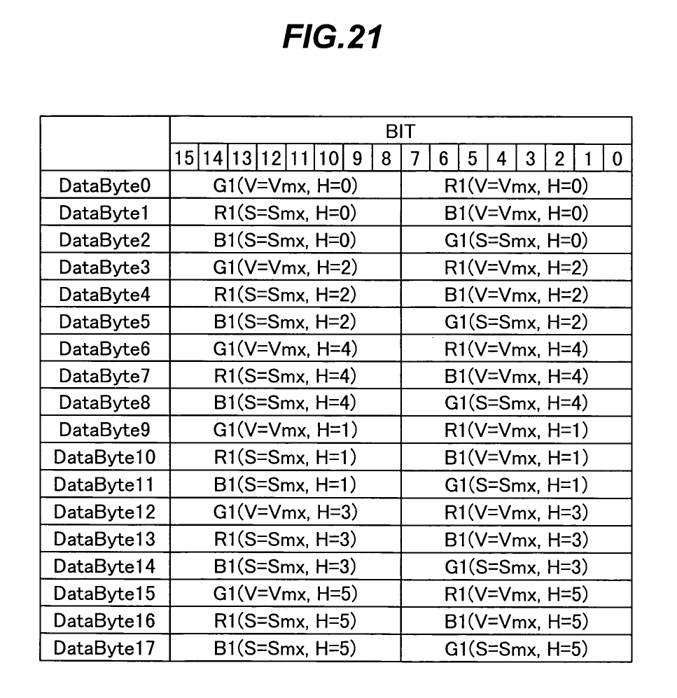

FIG. 21 shows an exemplary bit configuration of the gamut information Gmt generated in the gamut information generator 5e.

In this example, the first color data R1, G1, B1 in the maximum brightness information (the first color data of the red pixel that had a brightness V equal to the maximum value Vmx within a prescribed time interval), denoted R1(V=Vmx, H=0), G1(V=Vmx, H=0), B1(V=Vmx, H=0), are stored in bits 0 to 15 in DataByte0 and bits 0 to 7 in DataByte1; the first color data R1, G1, B1 in the maximum saturation information (the first color data of the red pixel that had a saturation S equal to the maximum value Smx within a prescribed time interval), denoted R1(S=Smx, H=0), G1(S=Smx, H=0), B1(S=Smx, H=0), are stored in bits 8 to 15 in DataByte1 and bits 0 to 15 in DataByte2. Similar data for other hues are stored as follows.

Data for green (H=2) are stored in DataByte3 to DataByte5.

Data for blue (H=4) are stored in DataByte6 to DataByte8.

Data for yellow (H=1) are stored in DataByte9 to DataByte11.

Data for cyan (H=3) are stored in DataByte12 to DataByte14.

Data for magenta (H=5) are stored in DataByte15 to DataByte17.

This information constitutes the gamut information Gmt.

This enables the gamut information Gmt to include the first color data of the pixels that produced the maximum brightness and saturation values for each hue.

### Embodiment 6

Instead of giving the first color data R1, G1, B1 of the pixel that produced the maximum saturation value and the first color data of the pixel that produced the maximum brightness value for each hue in the gamut information Gmt as in Embodiment 5, it is possible simply to give the maximum saturation value Smx and the maximum brightness value Vmx.

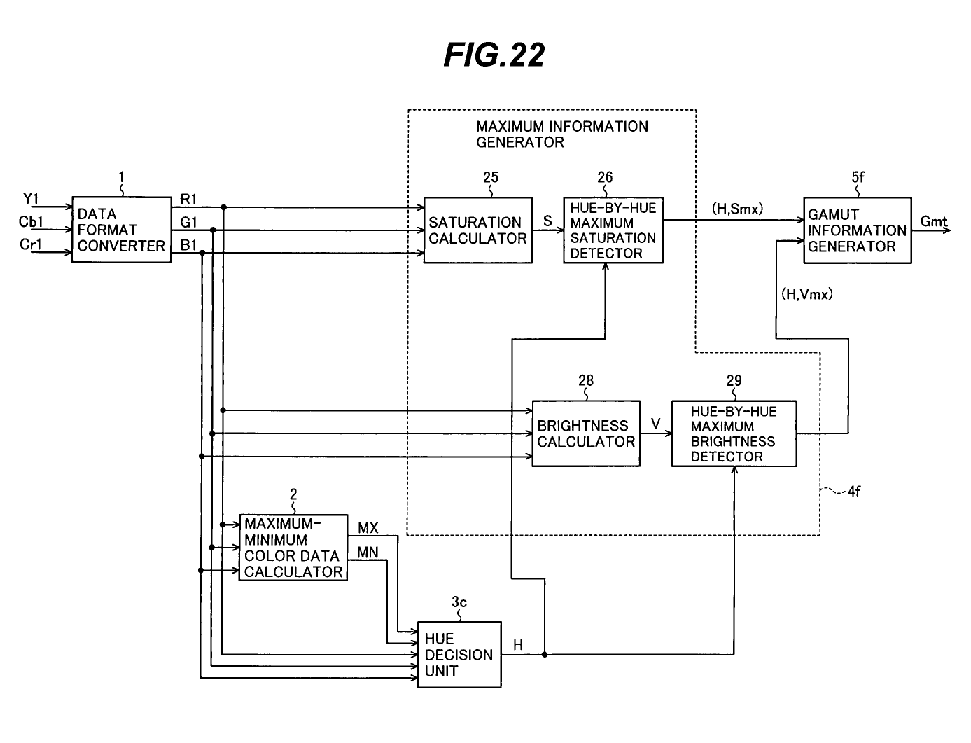

An exemplary image data processing apparatus using this method is illustrated in FIG. 22. This image data processing apparatus is substantially the same as in Embodiment 5 (FIG. 20), except that it includes a different maximum information generator 4f and gamut information generator 5f.

As shown in FIG. 22, the maximum information generator 4f includes a saturation calculator 25, a hue-by-hue maximum saturation detector 26, a brightness calculator 28, and a hue-by-hue maximum brightness detector 29.

The saturation calculator 25 calculates saturation S from the first color data R1, G1, B1, as described with reference to FIG. 20.

The hue-by-hue maximum saturation detector 26, also as described with reference to FIG. 20, receives data indicating the saturation S from the saturation calculator 25, obtains the maximum saturation value Smx for each hue in a prescribed time interval, and outputs the Smx value together with the hue information H as maximum saturation information (H, Smx) for each hue.

Similarly, the brightness calculator 28 calculates brightness V from the first color data R1, G1, B1.

The hue-by-hue maximum brightness detector 29 receives data indicating the brightness V from the brightness calculator 28, obtains the maximum brightness value Vmx for each hue in a prescribed time interval, and outputs the Vmx value together with the hue information H as maximum brightness information (H, Vmx) for each hue.

The gamut information generator 5f generates the gamut information Gmt by combining the maximum saturation information (H, Smx) and the maximum brightness information (H, Vmx) for each of the six hues, and outputs the result.

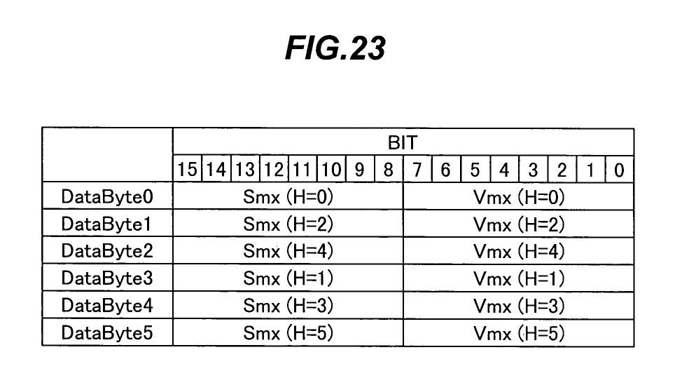

FIG. 23 shows an exemplary bit configuration of the gamut information Gmt generated in the gamut information generator 5f.

In this example, the maximum saturation Smx and the maximum brightness Vmx are stored in:

DataByte0 for the red hue (H=0);

DataByte2 for the green hue (H=2);

DataByte4 for the blue hue (H=4);

DataByte1 for the yellow hue (H=1);

DataByte3 for the cyan hue (H=3); and

DataByte5 for the magenta hue (H=5).

The configuration in Embodiment 6 enables the gamut information Gmt to be represented by saturation and brightness values instead of values of the first color data R1, G1, B1. Although this representation is more compact, in the image processing of RGB color data, in practice, gamut information Gmt giving the magnitudes of the first color data R1, G1, B1 is often processed more easily because this representation matches the signal space and accordingly does not require a transformation of color space coordinates.

### Variations

The configurations described in Embodiments 1 to 6 may be combined in practical use. For example, the metadata appender 6, which is used to append the gamut information to the first color data R1, G1, B1 as metadata in FIG. 5, may be included in the image data processing apparatus shown in FIG. 6, 11, 15, 20, or 22.

In the image data processing apparatus in FIG. 1, the hue decision unit 3a determines which of the three hues (red, green, and blue) a color represented by the first color data belongs to and the maximum-minimum information generator 4a generates maximum and minimum information for each of the three hues. In the image processing apparatus in FIG. 6, the hue decision unit 3b determines which of the six hues, red, green, blue, yellow, cyan, and magenta a color represented by the first color data belongs to and the maximum-minimum information generator 4b generates maximum and minimum information for each of the six hues. The image data processing apparatuses according to Embodiments 3 to 6 respectively shown in FIGS. 11, 15, 20, and 22 were described as using six hues as in Embodiment 2, but similar hue decision means and maximum and minimum information generating means (similar to the maximum-minimum information generator 4c in FIG. 11 and maximum-minimum information generator 4d in FIG. 15) or maximum brightness and saturation information generating means (similar to the maximum information generator 4e in FIG. 20 and maximum information generator 4f in FIG. 22) may be used to generate maximum and minimum information or the maximum brightness and saturation information for each of the three primary hues as in Embodiment 1.

The above embodiments dealt with first color data R1, G1, B1 that may take values less than 0% and values greater than 100%. Even when the first color data R1, G1, B1 do not take any such values, however, if color conversion or other similar processing related to a difference between the gamut of the first color data and the gamut displayable by an image display apparatus and other image output apparatus is required, the novel processing may be used to produce similar effects. When the first color data R1, G1, B1 take values less than 0% and values greater than 100%, some kind of processing must be performed to avoid color collapse. In this case, the novel processing can be used to output images that stay within the gamut of the image output apparatus and take maximum advantage of this gamut.

Those skilled in the art will recognize that further variations are possible within the scope of the invention, which is defined in the appended claims.

What is claimed is:

1. An image data processing apparatus for receiving image data including trichromatic input color data representing red, green, and blue and deriving gamut information from the image data, comprising:
a maximum-minimum information generator for generating maximum information and minimum information from the input color data in a prescribed time interval or data generated from the input color data in the prescribed time interval; and
a gamut information generator for generating the gamut information by using the maximum information and the minimum information.

2. The image data processing apparatus of claim 1, wherein:
the maximum information indicates a maximum value of the input color data occurring in the prescribed time interval or a value equivalent to the maximum value; and
the minimum information indicates a minimum value of the input color data occurring in the prescribed time interval or a value equivalent to the minimum value.

3. The image data processing apparatus of claim 2, wherein:
the maximum information indicates a maximum value of the input color data for each pixel in the prescribed time interval or a value equivalent to the maximum value; and
the minimum information indicates a minimum value of the input color data for each pixel in the prescribed time interval or a value equivalent to the minimum value.

4. The image data processing apparatus of claim 3, further comprising a maximum-minimum color data calculator for determining a maximum value and a minimum value of the input color data for each pixel, wherein:
the maximum-minimum information generator comprises a histogram generator for generating a histogram of the maximum values occurring in the prescribed time interval; and
a maximum-minimum detector for cumulatively adding frequencies of classes of the histogram in descending order and outputting a representative value of a class at which the cumulative sum first exceeds a first prescribed value as a value equivalent to the maximum value, and cumulatively adding frequencies of the classes of the histogram in ascending order and outputting a representative value of a class at which the cumulative sum first exceeds a second prescribed value as a value equivalent to the minimum value.

5. The image data processing apparatus of claim 2, wherein:
the maximum information indicates a maximum value of data representing each color component in the input color data in the prescribed time interval or a value equivalent to the maximum value; and
the minimum information indicates a minimum value of the data representing each color component in the input color data in the prescribed time interval or a value equivalent to the minimum value.

6. The image data processing apparatus of claim 5, further comprising a maximum-minimum color data calculator for determining a maximum value and a minimum value of the input color data for each pixel, wherein:
the maximum-minimum information generator comprises a histogram generator for generating a histogram of data representing each color component of the input color data; and
a maximum-minimum detector for cumulatively adding frequencies of classes of the histogram of the data representing each color component in descending order and outputting a representative value of a class at which the cumulative sum first exceeds a first prescribed value as a value equivalent to the maximum value, and cumulatively adding frequencies of classes of the histogram of the data representing each color component in ascending order and outputting a representative value of a class at which the cumulative sum first exceeds a second prescribed value as a value equivalent to the minimum value.

7. The image data processing apparatus of claim 1, wherein:
the maximum information comprises values of the input color data of a pixel at which a maximum value or a value equivalent to the maximum value occurred in the prescribed time interval; and
the minimum information comprises values of the input color data of a pixel at which a minimum value of the input data or a value equivalent to the minimum value occurred in the prescribed time interval.

8. The image data processing apparatus of claim 7, further comprising:
a maximum-minimum color data calculator for determining a maximum value and a minimum value of the input color data for each pixel; and
a low-pass filter for filtering the maximum value and the minimum value; wherein
the maximum-minimum information generator outputs information indicating a value of the input color data of a pixel at which a signal obtained by filtering of the maximum value in the low-pass filter takes a maximum value in the prescribed time interval, and outputs information indicating a value of the input color data of a pixel at which a signal obtained by filtering of the minimum value in the low-pass filter takes a minimum value in the prescribed time interval.

9. The image data processing apparatus of claim 1, further comprising a hue decision unit for generating hue information by deciding which hue a color represented by the input color data belongs to, wherein the maximum-minimum information generator generates the maximum information and the minimum information for each hue indicated by the hue information.

10. The image data processing apparatus of claim 9, wherein the hue information indicates to which one of the three hues, red, green, and blue the color represented by the input color data belongs.

11. The image data processing apparatus of claim 9, wherein the hue information indicates to which one of the six hues, red, yellow, green, cyan, blue, and magenta the color represented by the input color data belongs.

12. The image data processing apparatus of claim 1, wherein the trichromatic input color data may take values less than 0 percent and values larger than 100 percent.

13. The image data processing apparatus of claim 1, further comprising an appender for adding the color gamut information to the image data and outputting the image data with the appended color gamut information.

14. An image data processing apparatus for receiving trichromatic image data including input color data representing red, green, and blue and deriving gamut information from the image data, comprising:
a maximum information generator for generating maximum information of the input color data or data generated from the input color data in a prescribed time interval; and
a gamut information generator for generating the gamut information by using the maximum information.

15. The image data processing apparatus of claim 14, wherein the maximum information includes:
information indicating a value of the input color data of a pixel in which saturation calculated from the input color data takes a maximum value in the prescribed time interval; and
information indicating a value of the input color data of a pixel in which brightness calculated from the input color data takes a maximum value in the prescribed time interval.

16. The image data processing apparatus of claim 14, wherein the maximum information includes information indicating a maximum value of saturation calculated from the input color data in the prescribed time interval and information indicating a maximum value of brightness calculated from the input color data in the prescribed time interval.

17. The image data processing apparatus of claim 14, further comprising a hue decision unit for deciding a hue to which a color represented by the input color data belongs and generating hue information indicating the hue, wherein the maximum information generator generates the maximum information for each hue indicated by the hue information.

18. The image data processing apparatus of claim 17, wherein the hue information indicates to which one of the three hues, red, green, and blue the color represented by the input color data belongs.

19. The image data processing apparatus of claim 17, wherein the hue information indicates to which one of the six hues, red, yellow, green, cyan, blue, and magenta the color represented by the input color data belongs.

20. The image data processing apparatus of claim 14, wherein the trichromatic input color data may take values less than 0 percent and values larger than 100 percent.

21. The image data processing apparatus of claim 14, further comprising an appender for adding the color gamut information to the image data and outputting the image data with the appended color gamut information.

22. An image data processing method for deriving color gamut information about image data received as trichromatic input color data representing red, green, and blue, the image data processing method comprising:
generating maximum and minimum information of the input color data or data generated from the input color data in a prescribed time interval; and
generating the color gamut information by using the maximum information and the minimum information.

23. An image data processing method for deriving color gamut information about image data received as trichromatic input color data representing red, green, and blue, the image data processing method comprising:
generating maximum information of the input color data or data generated from the input color data in a prescribed time interval; and
generating the color gamut information by using the maximum information.

24. An image data processing method for providing color gamut information about image data received as input color data, the image data processing method comprising:
classifying the input color data into a plurality of hue ranges;
obtaining at least maximum information for each hue range in the plurality of hue ranges, the maximum information including one of a maximum trichromatic color data value, a maximum saturation value, and a maximum brightness value of the input color data in the hue range; and
outputting the at least maximum information obtained for all of the hue ranges as the gamut information.
